(19) United States
(12) Patent Application Publication
(10) Pub. No.: US 2012/0061475 A1
(43) Pub. Date: Mar. 15, 2012

(54) Method for Providing Inductively Coupled Radio Frequency Identification (RFID) Transponder, and RFID Transponder

(75) Inventors: Roland KUBE, Zirndorf (DE); Stadelmann Bernd, Egloffstein (DE)

(73) Assignee: Siemens Aktiengesellschaft, Munchen (DE)

(21) Appl. No.: 13/217,044

(22) Filed: Aug. 24, 2011

(30) Foreign Application Priority Data
Aug. 24, 2010 (EP) EP10173837

(51) Int. Cl. G06K 19/077; H01P 11/00

(52) U.S. Cl. 235/492; 29/600

(57) ABSTRACT

A radio frequency identification (RFID) transponder for use in an RFID arrangement with inductive coupling, where interaction of a transmitting and receiving coil with a ferrite component is provided for guiding the magnetic flux. Here, the ferrite component for guiding the magnetic flux includes a composite material comprising a plastic and ferrite powder, where the plastic is furnished in a laser-patternable manner, such that the transmitting and receiving coil is formed by at least one conductor track and then precontoured by laser processing metalized in or on a surface of the component. Such an RFID transponder is robust, easy and simple to produce.

### BACKGROUND OF THE INVENTION

1. Field of the Invention

The invention relates to radio frequency identification (RFID) transponders, and more particularly, to an RFID transponder, and a method for producing the RFID transponder.

2. Description of the Related Art

Mobile data memories that can be read contactlessly are often used for identifying goods, machines and other articles. In this case, optically readable barcode labels are increasingly being replaced by electromagnetically or magnetically writeable and readable radio frequency identification (RFID) labels, i.e., RFID transponders. In a preferred configurations, the RFID transponders operate without a dedicated power supply, such as a battery.

Different technologies are used in RFID transponders depending on the case of use. Thus, for labeling garments and other far field applications, for example, the RFID transponders are coupled to the reader by radio, i.e., by electromagnetic waves. However, inductively coupled RFID transponders will be considered below. These can be coupled to a writing and reading device, reader for short, by an alternating magnetic field and are often used in industrial applications in which short distances have to be bridged (i.e., near field detection).

Inductively coupled RFID transponders regularly have one or more transmitting and receiving coils by which the magnetic flux generated by a reader is converted into an AC voltage, where the AC voltage initially supplies the operating electronics of the RFID transponder with energy, and then contains information transmitted from the reader to the RFID transponder and information transmitted from the RFID transponder to the reader. With respect to the function of the RFID transponder, it is essential that the magnetic flux generated by the reader is substantially conducted through the area of the coil. However, this is problematic in cases in which the RFID transponder is operated on a metallic surface or in a depression or in a hole in a metallic workpiece. In these cases, often a large portion of the magnetic flux is conducted through the metallic workpiece and laterally past the transmitting and receiving coil (or simply coil), where the energy of the alternating magnetic field is largely converted into heat by eddy current losses and is therefore no longer available for supplying the RFID transponder. Conversely, the emissions of the RFID transponder in the case of an arrangement on a metallic workpiece are also largely conducted directly into the metallic workpiece, such that an undesirable attenuation can likewise be observed.

In order to solve the foregoing problem, it is known to provide between the transmitting and receiving coil of the RFID transponder and a metallic surface or a metallic workpiece a ferrite core (this also includes plate-shaped and pot-shaped components composed of ferrite material). As a result, the magnetic flux, i.e., the magnetic field lines, substantially coming from a receiving side opposite to the metallic workpiece, are conducted through the area of the transmitting and receiving coil and are then conducted away from the metallic workpiece to the receiving side again.

The RFID transponders described here therefore involve a construction that consists of at least three components, i.e., the operating electronics, the transmitting and receiving coil, and the ferrite core. A two-part housing is generally added, such that five components regularly have to be processed with one another. Alongside the resultant expenditure during assembly, it is disadvantageous that the conventional ferrite cores consist of brittle material and therefore cannot subsequently be altered, for example, by machining, etc., by a user, i.e., a manufacturer of RFID transponders, which user/manufacturer generally does not undertake the manufacture of the ferrite cores. Therefore, mechanical changes to the layout of the RFID transponder are not possible in a straightforward manner.

### SUMMARY OF THE INVENTION

It is therefore an object of the present invention to provide a method for simplifying the mechanical construction of a radio frequency identification (RFID) transponder.

This and other objects and advantages are achieved in accordance with the invention by using an inductively coupled RFID transponder having a ferrite component including a composite material comprising a plastic with embedded ferrite particles (ferrite powder), instead of using an RFID transponder having a conventional ferrite core. As a result, the composite material can be used to guide the magnetic flux in the region of the coil. For this purpose, the plastic on which the ferrite component is based is furnished in a laser-activateable manner, where a conductive metallic layer can subsequently be applied in regions in which the surface of the ferrite component is processed by a laser beam. In accordance with the method of the invention, a planar coil comprising a transmitting and receiving coil is applied to the surface of the ferrite component, where, in one advantageous embodiment of the invention, conductor tracks and soldering pads for the operating electronics are applied to the ferrite component in accordance with the method of the invention.

The method in accordance with the invention provides, in particular, an RFID transponder with inductive coupling for use in an RFID arrangement, where the interaction of a transmitting and receiving coil with a ferrite component is provided for guiding the magnetic flux, where the ferrite component for guiding the magnetic flux includes a composite material comprising a plastic and ferrite powder. Here, the plastic is furnished in a laser-patternable manner, such that the transmitting and receiving coil can be formed by at least one conductor track metalized and pre-contoured by laser processing in or on the surface of the component. In the case of such an RFID transponder, the ferrite component and the transmitting and receiving coil form an integrated component, with the result that simple assembly is afforded, the number of components assembled is reduced and a smaller design of the RFID transponder can be achieved.

In an embodiment of the method, an inductively coupleable RFID transponder is provided, where operating electronics are connected to a transmitting and receiving coil, and where a ferrite-comprising component for guiding the magnetic flux through the transmitting and receiving coil is provided. Here, the component is shaped from a composite material comprising a plastic and ferrite powder, where the plastic is furnished in a laser-activateable manner, such that a laser beam is used to apply or introduce the contour of a conductor track for the configuration of the transmitting and receiving coil in or on a surface of the component, after which the contour is metalized and contact-connected to the operating electronics. In accordance with the contemplated embodiment of the method, an RFID transponder having a small structural size can be produced in a simple and cost-effective manner, where malfunctions on account of cracks or fractures in the conventional brittle ferrite components are avoided.

In preferred embodiments, the plastic used is a liquid crystal polymer (LCP) which has robust mechanical properties and good resistance to chemical ambient influences. As a result, it is possible for the ferrite component to simultaneously form part of the housing of the RFID transponder. Moreover, liquid crystal polymer can be processed easily, in particular by casting or injection molding methods, such that, in cases in which the form of the ferrite component possibly needs to be changed, it is only necessary to adapt a mould for injection molding and it is unnecessary to commission the production of new hard ferrite cores.

In another embodiment, the ferrite component comprises conductor tracks for the components of the operating electronics that have also been metalized and precontoured by the laser processing, after which the electronic components of the operating electronics can be fitted directly on the ferrite component, for example, by soldering, bonding, adhesive bonding or other types of contact-connection. As a result, it is possible to eliminate the requirement to provide a separate printed circuit board for the operating electronics.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

One exemplary embodiment of the RFID transponder in accordance with the invention and method for producing the RFID transponder is explained below with reference to the drawings, in which:

FIG. 1 is a schematic block diagram of a ferrite component with a transmitting and receiving coil, which is applied by a laser patterning and metalization method in accordance with the invention; and

FIG. 2 is a flowchart of the method in accordance with an embodiment of the invention.

### DETAILED DESCRIPTION OF THE PREFERRED EMBODIMENTS

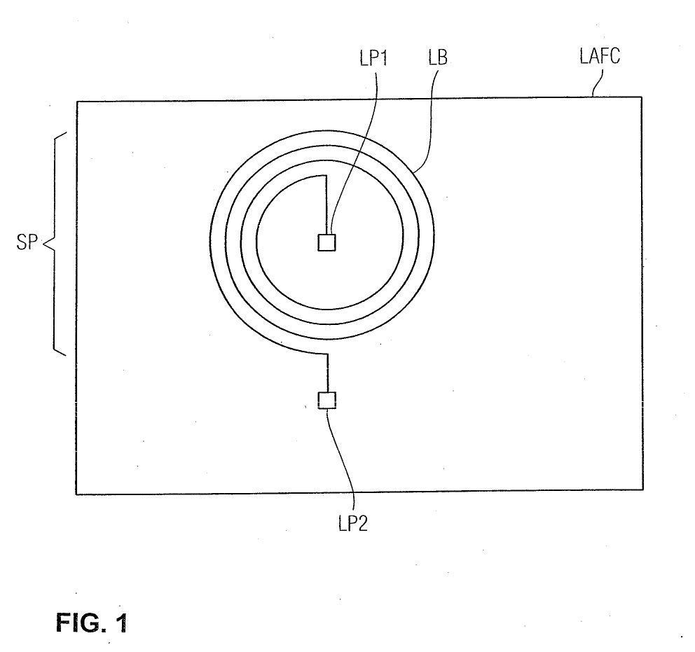

FIG. 1 is schematic illustration of a ferrite component laser-activated ferrite compound (LAFC) which consists of a liquid crystal polymer (LCP) and which is furnished in a laser-activateable manner. That is, a laser beam can be used to trace lines and areas on the surface of the ferrite component LAFC, thus resulting in a change in the surface constitution in regions processed by the laser light. In addition, it should be noted that a modified polymer is present in these processed regions. This method is known as laser direct patterning (LDP). The present inventors have determined that the modified liquid crystal polymer, which is therefore furnished with an additive for the laser activateability, can be enriched with ferrite particles, without the insulating properties (electrical insulation) and the laser activateability being impaired. The ferrite component LAFC shown here includes a laser-activateable plastic enriched with ferrite particles in this way, where, with the use of a laser beam, at least one coil SP for an inductively coupleable RFID transponder has been traced by laser light and formed as an electrically conductive coil SP by a subsequent metalization method. Here, the coil comprises the conductor track LB. In contrast to the coil SP schematically shown here, the coil SP of a real arrangement is configured with a core region free of conductor tracks and having the largest possible area, where the turns of the coil are concentrated in the edge region.

Depending on the intensity of the laser processing, the conductor track LB can be arranged either on the surface or in a manner embedded in the surface of the ferrite component LAFC. In one advantageous embodiment (not shown), “multi-layer” arrangements comprising a plurality of layers with conductive structures can also be produced. In particular, it is possible to provide the rear side of the ferrite component with conductor tracks and to connect the rear side to the front side by plated-through holes.

While only one coil SP is illustrated in the FIG. 1 for reasons of clarity, in a real component it is also possible to provide a plurality of coils on one ferrite component, where these coils are, for example, connected in parallel or linked to one another by a switching matrix, i.e., by a butler matrix, such that improved transmitting and receiving properties arise in comparison the transmitting and receiving properties provided by an individual coil SP.

The coil SP is provided with contact-making springs soldering pad LP1, LP2, whereby operating electronics (not shown) of the RFID transponder can be connected to the coil SP. In certain embodiments, the contact-connection is effected by soldering, bonding, spring contacts or crimping.

Although in FIG. 1 the ferrite component LAFC is illustrated as a rectangular plate, other geometries can also be produced depending on the dimensions of the RFID transponder to be created and the specific installation situation, where due to the injection molding method that is preferably to be employed, only the mould used for injection molding has to be changed for a changed geometry. Moreover, a molded workpiece composed of the material proposed here can subsequently be processed, for example, by machining. This is generally not possible in the case of the conventional ferrite cores, because this brittle material, during mechanical processing, often takes cracks or fractures therefrom. Spacers and fixing devices, i.e., “latching lugs” or engagement devices for plastic snap-action connections, can be integrally formed in or on the rear side (not illustrated) of the ferrite component LAFC.

In one particularly advantageous embodiment, alongside the conductor track LB and the contact-making areas (contact-making springs soldering pad) LP1, LP2, it is also possible to apply all the other conductor tracks and contact areas for the operating electronics (not illustrated) of the RFID transponder on the ferrite component LAFC, such that, after population with the electronic components, no further printed circuit board or conductor foil has to be provided and making contact with external components can be obviated. A molded interconnected device (MID) arises, where a guide of the magnetic flux is additionally integrated into this component.

In general, the material used for the RFID transponder in accordance with the invention is a shaping carrier material which can be used as a component carrier and which has conductor track structures with which inductances (antenna structure) can be simulated. In addition, complex ferrite structures can be formed by the magnetic properties of the compound material used, as a result of which it is possible to achieve a defined guidance of the magnetic flux through the antenna structure (i.e., coil SP).

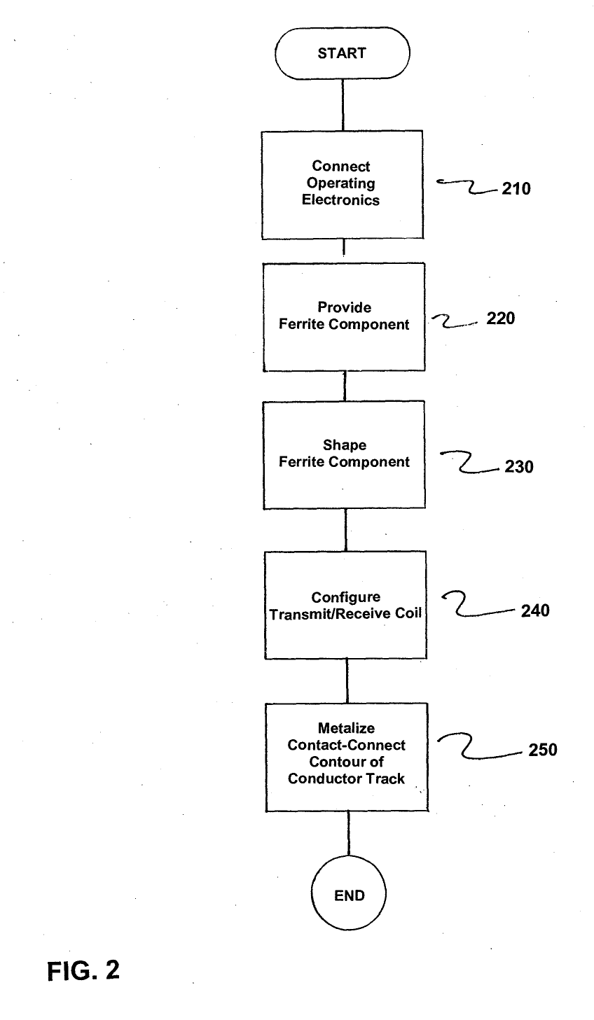

FIG. 2 is a flowchart of a method for producing an inductively coupleable radio frequency identifier (RFID) transponder. The method comprises connecting operating electronics to a transmitting and receiving coil SP, as indicated in step 210. A ferrite component LAFC is provided for guiding a magnetic flux through the transmitting and receiving coil SP, as indicated in step 220.

The ferrite component LAFC is shaped from a composite material comprising a plastic and ferrite powder, as indicated in step 230. Here, the plastic is furnished in a laser-activateable manner.

A contour of a conductor track LB is applied or introduced with a laser beam to configure the transmitting and receiving coil SP in or on a surface of the ferrite component, as indicated in step 240. The contour of the conductor track is metalized and contact-connected to the operating electronics.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A radio frequency identification (RFID) transponder for an RFID arrangement having inductive coupling, comprising:
a transmitting and receiving coil; and
a ferrite component for guiding a magnetic flux, the ferrite component for guiding the magnetic flux interacting with the transmitting and receiving coil and comprising a composite material comprised of a plastic and ferrite powder, and the plastic being furnished in a laser-patternable manner;
wherein the transmitting and receiving coil is formed by at least one conductor track metalized and precontoured by laser processing in or on a surface of the component.

2. The RFID transponder as claimed in patent claim 1, wherein the plastic is a liquid crystal polymer.

3. The RFID transponder as claimed in patent claim 1, wherein the ferrite component comprises conductor tracks of operating electronics that have been metalized and precontoured by laser processing; and wherein electronic components of the operating electronics are fitted on the ferrite component.

4. The RFID transponder as claimed in patent claim 2, wherein the ferrite component comprises conductor tracks of operating electronics that have been metalized and precontoured by laser processing; and wherein electronic components of the operating electronics are fitted on the ferrite component.

5. A method for producing an inductively coupleable radio frequency identifier (RFID) transponder, comprising:
connecting operating electronics to a transmitting and receiving coil;
providing a ferrite component for guiding a magnetic flux through the transmitting and receiving coil;
shaping the ferrite component from a composite material comprising a plastic and ferrite powder, the plastic being furnished in a laser-activateable manner;
applying or introducing, with a laser beam, a contour of a conductor track to configure the transmitting and receiving coil in or on a surface of the ferrite component; and
metalizing and contact-connecting the contour of the conductor track to the operating electronics.

6. The method as claimed in patent claim 4, wherein the plastic comprises a liquid crystal polymer.

7. The method as claimed in patent claim 5, further comprising
providing the ferrite component by laser processing with pre-contoured and metalized conductor tracks of the operating electronics; and
fitting the electronic components of the operating electronics on the ferrite component after providing the pre-contoured and metalized conductor tracks of the operating electronics.

8. The method as claimed in patent claim 6, further comprising
provided the ferrite component by laser processing with pre-contoured and metalized conductor tracks of the operating electronics; and
fitting the electronic components of the operating electronics on the ferrite component after providing the pre-contoured and metalized conductor tracks of the operating electronics.
